(19) United States
(12) Patent Application Publication
(10) Pub. No.: US 2013/0040771 A1
(43) Pub. Date: Feb. 14, 2013

(54) POWER TRANSMISSION BELT, IN PARTICULAR TOOTHED BELT

(71) Applicant: ContiTech Antriebssysteme GmbH, Hannover (DE)

(72) Inventors: Michael Well, Vechelde (DE); Reinhard Teves, Seelze (DE)

(73) Assignee: CONTITECH ANTRIEBSSYSTEME GMBH, Hannover (DE)

(21) Appl. No.: 13/653,143

(22) Filed: Oct. 16, 2012

Related U.S. Application Data
(63) Continuation of application No. PCT/EP2011/054508, filed on Mar. 24, 2011.

(30) Foreign Application Priority Data
May 3, 2010 (DE) 10 2010 016 757.6
Jul. 7, 2010 (DE) 10 2010 017 782.2

(51) Int. Cl. F16G 1/26

(52) U.S. Cl. 474/205

(57) ABSTRACT

A power transmission belt having an elastic basic body, comprising a top layer as a belt spine and comprising a substructure with a power transmission zone, wherein the basic body is composed of an at least partially vulcanized natural rubber mixture which contains at least one natural rubber component and at least one filler material and at least one reactive diluent in accordance with DIN 55945:2007 March.

### CROSS REFERENCE TO RELATED APPLICATIONS

This application is a continuation application of international patent application PCT/EP 2011/054508, filed Mar. 24, 2011, designating the United States and claiming priority from German application nos. 10 2010 016 757.6 and 10 2010 017 782.2, filed May 3, 2010 and Jul. 7, 2010, respectively, and the entire content of the above applications is incorporated herein by reference.

### FIELD OF THE INVENTION

The invention relates to a force-transmission belt with an elastic main body, comprising an outer layer as belt backing and a substructure with a force-transmission zone.

### BACKGROUND OF THE INVENTION

Force-transmission belts are also termed drive belts and, in the functional condition, are mostly endless belts, and can take the form of flat belts, V-belts, V ribbed belts, and toothed belts.

In order to achieve the elasticity of a drive belt, the main body, and therefore the outer layer and the substructure, are composed of a polymeric material with elastic properties, and the two groups of materials that should be mentioned in particular here are elastomers and thermoplastic elastomers. Elastomers based on a vulcanized rubber mixture are of particular importance.

The rubber mixtures used in an elastic main body of a toothed belt in particular must have good flowability to flow through the plane comprising the wound tension members and form the teeth during the vulcanization process. If these teeth are intended to be very hard, to be capable of withstanding relatively high mechanical loads and thus prolonging lifetime, the method generally used to achieve this is merely to increase the proportion of filler in the rubber mixture, for example by adding short fibers, and/or to implement a controlled increase in crosslinking yield. The result is a severe increase in the viscosity of the crude mixture, and the flowability is then no longer sufficient to form the teeth. This effect can frequently be encountered when, for plant-related reasons, the vulcanization pressures are small. Equally, attempts are made to use specific polymers or defined polymer combinations to influence the hardness of the rubber mixture. Reference may be made at this point to the appropriate publications, for example, United States patent application publication 2005/0090618, United States patent application publication 2006/0079362, U.S. Pat. No. 4,048,865, U.S. Pat. No. 6,358,171, U.S. Pat. No. 5,234,387 and U.S. Pat. No. 5,599,246.

### SUMMARY OF THE INVENTION

It is therefore an object of the present invention to provide a force-transmission belt which has an elastic main body composed of at least one rubber mixture with high hardness and low mixture viscosity, to provide not only good shaping performance but also long lifetime. Shore A hardness here should preferably be greater than 85, and viscosity should preferably be smaller than 2000 Pa*s.

The object is achieved in that the main body is composed of an at least partially vulcanized rubber mixture which comprises at least one rubber component and at least one filler and at least one reactive diluent in accordance with DIN 55945:2007 March.

Surprisingly, it has been found that rubber mixtures for the main body of a force-transmission belt exhibit high hardness together with very low viscosity and therefore good flow behavior when the rubber mixture comprises at least one reactive diluent in accordance with DIN 55945:2007 March.

The rubber mixture of the main body comprises at least one rubber component. The following are in particular used as rubber component: ethylene-propylene rubber (EPM), ethylene-propylene-diene rubber (EPDM), (partially) hydrogenated nitrile rubber (HNBR), fluororubber (FKM), natural rubber (NR), styrene-butadiene rubber (SBR), or butadiene rubber (BR), and these may be unblended or blended with at least one further rubber component, in particular with one of the above-mentioned types of rubber, for example in the form of an EPM/EPDM blend or SBR/BR blend. A particularly important material here is HNBR, or else EPM, EPDM, or an EPM/EPDM blend.

Thermoplastic elastomers (TPEs) that can be used are in principle any of the TPEs known to the person skilled in the art. Those that may be highlighted here are olefin-based thermoplastic elastomers (TPOs), styrene triblock copolymers (SBS, SIS, SEC), thermoplastic nitrile rubber (TP-NBR), thermoplastic natural rubber (TP-NR), thermoplastic fluororubber (TP-FKM), thermoplastic silicone rubber (TP-Q), thermoplastic polyurethanes (TPUs), copolymer polyetheresters (CPE, CPA), polyether block amides (PEBAs), and melt processable rubber (MPR).

The TPEs can also be used in a blend with one or more elastomers.

The rubber mixture of the main body also comprises at least one filler. It is advantageous that this involves at least one carbon black or involves at least one silica. The combination of carbon black and silica has proven particularly suitable. It is possible here to use any of the silicas known in the rubber industry, preferably precipitated silicas. Equally, it is possible to use any of the known types of carbon black, in particular furnace blacks and thermal blacks, such as SAF, SCF, HAF, FF, FEF, XCF, HMF, GPF, SRF, MPF, FT, or MT, and particular preference is given here to FEF carbon blacks.

The reactive diluent in accordance with DIN 55945:2007 March is one selected from the group of the methacrylates and/or of the acrylates and/or vinyl ethers and/or glycidyl ethers, particular preference being given here to methacrylates and/or acrylates.

If acrylates are used, these preferably have isocyanate groups. Preference is equally given to difunctional groups at the chain end of the reactive diluent.

In one particularly preferred embodiment, the reactive diluent involves urethane acrylate (UA) and/or dipropylene glycol diacrylate (DPGDA) and/or tripropylene glycol diacrylate (TPGDA) and/or hexanediol diacrylate (HDDA), preferably hexane-1,6-diol diacrylate (1,6-HDDA) and/or trimethylolpropane triacrylate (TMPTA), and/or diurethane dimethacrylate (HEMA-MDI).

In each case it is possible to use just one reactive diluent or a reactive diluent in combination with at least one other reactive diluent.

In particular, the use of urethane acrylate can also increase the polarity in the mixture, thus reducing swelling of the force-transmission belt in nonpolar fluids.

It has proven to be advantageous to use amounts of from 0.1 to 30% by weight of the reactive diluent mentioned, preferably amounts of from 0.5 to 25% by weight, particularly preferably amounts of from 1 to 20% by weight.

The reactive diluent here can also comprise solvents. The quantitative data relate in this case to reactive diluent inclusive of solvents.

The measurement phr (parts per hundred parts of rubber by weight) used in this specification is the conventional measurement for mixture formulations in the rubber industry. The amount added in parts by weight of the individual substances here is always based on 100 parts by weight of the entire composition of all of the rubbers present in the mixture.

The mixture ingredients of the rubber mixture also comprise at least one crosslinking agent or one crosslinking agent system (crosslinking agent and accelerator). Other mixture ingredients are mostly processing aids and/or plasticizers and/or antioxidants, and also optionally other additional materials, for example fibers for reinforcement, and color pigments. It is advantageous to admix uniformly dispersed fibers made of aramid, cotton, carbon, or cellulose with the rubber mixture, and it is particularly preferable to use aramid fibers here, and more particularly para-aramid fibers. In this connection, reference is made to the general prior art in rubber mixture technology.

Force-transmission belts are usually crosslinked peroxidically, and any of the peroxidic crosslinking agents and crosslinking aids known to the person skilled in the art can be used here. However, it is entirely possible to use other types of crosslinking, for example radiation crosslinking.

Any reinforcement systems, frequently in the form of tension members, that may be present in the force-transmission belt are composed of steel, polylamide, aramid, polyester, glass fibers, carbon fibers, polyether ether ketone (PEEK), or polyethylene 2,6-naphthalate (PEN).

An optional textile covering is advantageously composed of a woven, a warp-knitted or a weft-knitted fabric. It is preferable that the material used for the woven, warp-knitted or weft-knitted fabric comprises cotton or other natural fibers, for example flax, linen, or hemp. Further, it is also equally possible to use aramid, nylon, and/or polyester. The textile covering can also have a separate coating comprising a reactive diluent in accordance with DIN 55945:2007 March.

The rubber mixture of the elastic main body can equally comprise a reactive diluent of this type.

The force-transmission belt is used as a flat belt, V belt, V-ribbed belt, or toothed belt, where particular preference is given to the latter.

In one particularly preferred embodiment, the force-transmission belt has at least one coating. Especially the force-transmission zone and/or the outer layer can respectively have a coating, and it is also possible here that the coating completely sheathes the belt. A coating of this type is applied inter alia when, by way of example, there are particular additional requirements relating to abrasion, noise reduction, or oil resistance.

Exemplary embodiments will now be used to present more detail of the invention. Tables 1a and 2a show the corresponding rubber compositions of the main body, while Tables 1b and 2b show experimental results. “C” indicates comparative mixtures known from the prior art, while “I” indicates compositions of the invention.

The results in Tables 1b and 2b were based on the following test specifications:
Shore A hardness in accordance with DIN 53 505
strength, elongation, and 50% modulus in accordance with DIN 53 504, DIN 53455, and DIN 53571
relative degree of crosslinking of 10% (t10, scorch time) and 90% (t90, vulcanization completion time) and torque Fa and, respectively, Fe by means of rotorless vulcameter (MDR=moving die rheometer) in accordance with DIN 53 529
Mooney viscosity in accordance with ASTM D1646
viscosity by means of (Göttfert) Rheotester, nozzle: 1 mm, channel length: 12.0 mm; ram velocity: 0.63 mm/s; temperature: 80° C.

TABLE 1a

| Mixture constituents | C1 | I1 |
|---|---|---|
| HNBR (a) | 60 | 60 |
| HNBR (b) | 40 | 40 |
| Carbon black (c) | 15 | 15 |
| Silica (d) | 15 | 15 |
| Fibers (e) | 5 | 5 |
| Reactive diluent (f) | — | 10 |
| Stearic acid | 1 | 1 |
| Plasticizer (g) | 7 | 7 |
| Zinc oxide | 5 | 5 |
| Antioxidant (h) | 2 | 2 |
| Vulcanizing agent (i) | 2 | 2 |
| Vulcanizing agent (j) | 6 | 8 |

(a) Zetpol ® 2011, Zeonchemicals
(b) HNBR modified with Zn methacrylate, Zeoforte ® ZSC 2295, Zeonchemicals
(c) N550
(d) Ultrasil ® VN3, Evonik Degussa
(e) 3 mm para-aramid fibers (e.g. Twaron ® fibers or Technora ® fibers)
(f) hexanediol diacrylate (HDDA), Laromer ® HDDA, BASF
(g) di(2-ethylhexyl) sebacate, Edenol ® 888, Emery Oleochemicals GmbH
(h) 4,4′-bis(α,α-dimethylbenzyl)diphenylamine, Naugard ® 445, Chemtura
(i) zinc salt of 4- and 5-methyl-2-mercaptobenzimidazole (ZMMBI), Vulkanox ® ZMB2, Lanxess
(j) di(tert-butylperoxyisopropyl)benzene, Perkadox ® 1440, Akzo

TABLE 1b

| Properties | [unit] | C1 | I1 |
|---|---|---|---|
| MDR 2000, 180° C. | | | |
| Fa | dNm | 1.65 | 1.13 |
| Fe | dNm | 38.42 | 69.04 |
| Fe − Fa | dNm | 36.77 | 67.91 |
| t10 | min | 0.36 | 0.28 |
| t90 | min | 4.29 | 4.84 |
| Mooney M_{L} (1 + 4) at 100° C. | | 79 | 42 |
| Viscosity | Pa*s | 2800 | 1730 |
| 20 min, 180° C. heating time | | | |
| Hardness | Shore A | 85 | 93 |
| Strength (longitudinal) | MPa | 15.4 | 19.5 |
| Strength (transverse) | MPa | 15.8 | 16.4 |
| Elongation (longitudinal) | % | 177 | 57 |
| Elongation (transverse) | % | 264 | 121 |
| 50% modulus (longitudinal) | MPa | 15.2 | 19.3 |
| 50% modulus (transverse) | MPa | 6.1 | 9.3 |

TABLE 2a

| Mixture constituents | C1 | I2 | I3 |
|---|---|---|---|
| HNBR (i) | 60 | 60 | 60 |
| HNBR (ii) | 40 | 40 | 40 |
| Carbon black (iii) | 15 | 15 | 15 |
| Silica (iv) | 15 | 15 | 15 |
| Fibers (v) | 5 | 5 | 5 |
| Reactive diluent (vi) | — | 10 | — |
| Reactive diluent (vii) | — | — | 10 |
| Stearic acid | 1 | 1 | 1 |
| Zinc oxide | 5 | 5 | 5 |
| Antioxidant (viii) | 2 | 2 | 2 |
| Vulcanizing agent (ix) | 2 | 2 | 2 |
| Vulcanizing agent (x) | 6 | 8 | 8 |

(i) Zetpol ® 2011, Zeonchemicals
(ii) HNBR modified with Zn methacrylate, Zeoforte ® ZSC 2295, Zeonchemicals
(iii) N550
(iv) Ultrasil ® VN3, Evonik Degussa
(v) 3 mm para-aramid fibers (e.g. Twaron ® fibers or Technora ® fibers)
(vi) aliphatic urethane acrylate, 65%, dissolved in tripropylene glycol diacrylate (TPGDA), Laromer ® UA 19 T, BASF
(vii) unsaturated polyester resin, 55%, dissolved in dipropylene glycol diacrylate (DPGDA), Laromer ® UP 35 D, BASF
(viii) 4,4′-bis(α,α-dimethylbenzyl)diphenylamine, (Naugard ® 445, Chemtura
(ix) zinc salt of 4- and 5-methyl-2-mercaptobenzimidazole (ZMMBI), Vulkanox ® ZMB2, Lanxess
(x) di(tert-butylperoxyisopropyl)benzene, Perkadox ® 1440, Akzo

TABLE 2b

| Properties | [unit] | C1 | I2 | I3 |
|---|---|---|---|---|
| MDR 2000, 180° C. | | | | |
| Fa | dNm | 1.65 | 1.26 | 1.33 |
| Fe | dNm | 38.42 | 53.55 | 61.42 |
| Fe − Fa | dNm | 36.77 | 52.29 | 60.09 |
| t10 | min | 0.36 | 0.31 | 0.30 |
| t90 | min | 4.29 | 4.87 | 4.77 |
| Mooney M_{L} (1 + 4) at 100° C. | | 79 | 49 | 50 |
| Viscosity | Pa*s | 2800 | 1834 | 1962 |
| 20 min, 180° C. heating time | | | | |
| Hardness | Shore A | 85 | 91 | 92 |
| Strength (longitudinal) | MPa | 15.4 | 17.3 | 18.3 |
| Strength (transverse) | MPa | 15.8 | 16.5 | 17.8 |
| Elongation (longitudinal) | % | 177 | 141 | 76 |
| Elongation (transverse) | % | 264 | 194 | 177 |
| 50% modulus (longitudinal) | MPa | 15.2 | 17.3 | 18.1 |
| 50% modulus (transverse) | MPa | 6.1 | 7.3 | 7.6 |

From the results in Tables 1b and 2b it is clear that addition of a reactive diluent in accordance with DIN 55945:2007 March to the rubber mixture for the main body significantly increases hardness, shown as Shore A hardness. At the same time, a reactive diluent of this type acts as plasticizer in the rubber mixture, and specifically with the effect of markedly reducing mixture viscosities (see Mooney viscosity and especially viscoelastomer data). This provides good shaping performance together with long lifetime.

### BRIEF DESCRIPTION OF THE DRAWINGS

The invention will now be described with reference to the drawings wherein:

FIG. 1 is a three-dimensional representation of a toothed belt, using a plan view of the force-transmission zone; and,

FIG. 2 is a longitudinal section through a toothed belt with a protective layer for the force-transmission zone and for the belt backing.

### DESCRIPTION OF THE PREFERRED EMBODIMENTS OF THE INVENTION

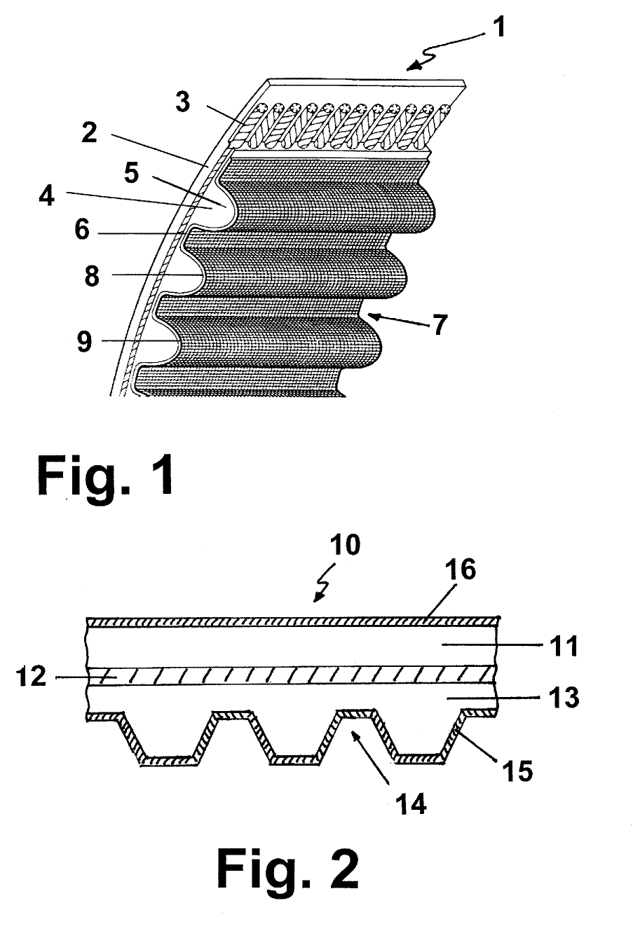

FIG. 1 shows a force-transmission belt 1 in the form of a toothed belt using an outer layer 2 as belt backing, with a plurality of embedded and parallel tension members 3 as reinforcement system, and also with a substructure 4. The outer layer and the substructure here form, as entire unit, the elastic main body, which is composed of a vulcanizate based on an HNBR and on a modified HNBR, carbon black, and silica as filler, and on a reactive diluent in accordance with DIN 55945:2007 March. The tension members are composed of steel, polyamide, aramid, polyester, glass fibers, carbon fibers, polyether ether ketone (PEEK), or polyethylene 2,6-naphthalate (PEN).

The substructure 4 has toothed profiling, comprising teeth 5 and spaces 6 between the teeth, and forms the force-transmission zone 7, which is particularly susceptible to wear through abrasion, heat, and the effect of oils. For this reason, a previous proposal provides the force-transmission zone with a textile covering 8, for example in the form of a woven or knitted material. The woven covering is, according to the teaching of U.S. Pat. No. 7,749,118 and United States patent application publication 2010/024081, also saturated with a fluorine-containing plastic, which in particular is PTFE, and specifically with a high fill level of the plastic, where a polymer coating (seal) is simultaneously formed as additional protective layer 9. The two sublayers 8 and 9 with different functions appear here as a combined protective layer.

The force-transmission belt 10 in FIG. 2 again takes the form of a toothed belt and comprises an outer layer 11 as belt backing, tension members 12, and a substructure 13 with a toothed force-transmission zone 14. The force-transmission zone has a protective layer 15, and the belt backing has a protective layer 16.

A protective layer of this type can by way of example be composed of polyurethane, of a fluorine-containing plastic, which in particular is polytetrafluoroethylene (PTFE), polyvinyl fluoride (PVF), or polyvinylidene fluoride (PVDF), or of a mixture of the materials mentioned.

The protective layers 15 and 16 here can, as in the embodiment in U.S. Pat. No. 7,749,118 and United States patent application publication 2010/024081, be present in conjunction with a textile covering, for example a woven material, or else can also be used in the form of foils or of a foil composite, and specifically in particular without use of a textile covering. In this connection, particular reference is made to the relatively recent development in DE 10 2008 012 044.8.

Protective layers of this type are in particular used for high-performance toothed belts.

It is understood that the foregoing description is that of the preferred embodiments of the invention and that various changes and modifications may be made thereto without departing from the spirit and scope of the invention as defined in the appended claims.

### KEY

### (Part of the Description)

1 Force-Transmission Belt (Toothed Belt)
2 Outer layer as belt backing
3 Reinforcement system in the form of tension members
4 Substructure
5 Tooth
6 Space between teeth
7 Force-transmission zone
8 Textile covering (tooth covering)
9 Protective layer
10 Force-transmission belt (toothed belt)
11 Outer layer as belt backing
12 Reinforcement system in the form of tension members
13 Substructure
14 Force-transmission zone
15 Protective layer for force-transmission zone
16 Protective layer for belt backing

What is claimed is:

1. A force-transmission belt with an elastic main body, comprising:
an outer layer as belt backing and
a substructure with a force-transmission zone, wherein the main body is composed of an at least partially vulcanized rubber mixture of at least one rubber component, at least one filler and at least one reactive diluent in accordance with DIN 55945:2007 March.

2. The force-transmission belt as claimed in claim 1, wherein the elastomer is a partially or completely hydrogenated nitrile rubber.

3. The force-transmission belt as claimed in claim 1, wherein the filler is carbon black.

4. The force-transmission belt as claimed in claim 1, wherein the filler is silica.

5. The force-transmission belt as claimed in claim 1, wherein a mixture of carbon black and silica is used as filler.

6. The force-transmission belt as claimed in claim 1, wherein the reactive diluent in accordance with DIN 55945:2007 March is one selected from the group consisting of methacrylates, acrylates, vinyl ethers, and glycidyl ethers, or a mixture thereof.

7. The force-transmission belt as claimed in claim 6, wherein the reactive diluent in accordance with DIN 55945:2007 March is selected from the group consisting of the methacrylates, acrylates, or a mixture thereof.

8. The force-transmission belt as claimed in claim 1, wherein the rubber mixture comprises from 0.1 to 30 phr of the reactive diluent in accordance with DIN 55945:2007 March.

9. The force-transmission belt as claimed in claim 1, wherein fibers have been mixed into the rubber mixture.

10. The force-transmission belt as claimed in claim 1, wherein the force-transmission zone, the outer layer, or the force-transmission zone and the outer layer have been provided with an additional coating.

11. The force-transmission belt as claimed in claim 1, wherein the drive belt is a toothed belt.
